(19) United States
(12) Patent Application Publication
(10) Pub. No.: US 2011/0256765 A1
(43) Pub. Date: Oct. 20, 2011

(54) CONNECTION MODULE

(75) Inventors: Kevin James Truskett, New South Wales (AU); Bryce Nicholls, New South Wales (AU); Simon Ellis, New South Wales (AU); Brett Hoe Slater, New South Wales (AU); Wayne William Dennes, New South Wales (AU); Malcolm Bruce Brear, New South Wales (AU); Tam Kai Sau, Singapore (SG)

(73) Assignee: ADC GmbH, Berlin (DE)

(21) Appl. No.: 13/123,791

(22) PCT Filed: Oct. 12, 2009
(86) PCT No.: PCT/EP2009/007314

§ 371 Date: Apr. 12, 2011

(30) Foreign Application Priority Data
Oct. 14, 2008 (SG) 200807705-9

(51) Int. Cl. H01R 24/00; H01R 13/648

(52) U.S. Cl. 439/607.01; 439/626

(57) ABSTRACT

The invention relates to a connecting module with two parallel rows of contact elements having conductor connecting contacts which are accessible from a front side of the connecting module, and two parallel rows of contact elements having conductor connecting contacts which are accessible from a rear side of the connecting module, wherein the conductor connecting contacts in one row on the front side are in each case connected to a conductor connecting contact in one row on the rear side via at least an intermediate contact, into which an insertion device can be inserted.

The invention relates to a connecting module for telecommunications and data technology.

A connecting module, also known as a cross connect block, for use in a telecommunications system is known. This cross connect block allows a subscriber line to be connected to a pair gain system of a telephone network as well as a digital subscriber line (DSL) system, for example. The cross connect block has two rows of contact elements that are provided with conductor connecting contacts at either end. The contact elements extend from a front side of the block to a rear side of the block to allow for a circuit to be established between wires connected on the front side of the block and wires connected on the rear side of the block. As such, a pair of wires from a subscriber line can be connected on a rear side of the block, in electrical connection with a pair of wires from a DSL system on a front side of the block.

The cross connect block also facilitates electrical connection across the block by providing access for electrically conductive components to be inserted between the rows of the conductors, to thereby form connections with additional circuits, such as between the pair gain system and DSL system, via lines terminated at opposite sides of the block. A cross connector block that incorporates the above-described functions is described in detail in PCT/AU2008/000980.

Given the above considerations, it is generally desirable to increase the functionality of known connecting modules.

The technical problem on which the invention is based is that of providing a compact connecting module with greater flexibility.

The technical problem is solved by the subject matter having the features of claim 1. Further advantageous refinements of the invention are specified in the dependent claims.

To this end, the connecting module comprises two parallel rows of contact elements having conductor connecting contacts which are accessible from a front side of the connecting module, and two parallel rows of contact elements having conductor connecting contacts which are accessible from the rear side of the connecting module, wherein the conductor connecting contacts in one row on the front side are in each case connected to a conductor connecting contact in one row on the rear side via at least an intermediate contact, into which an insertion device can be inserted. The conductor connecting contacts are preferably in the form of insulation displacement contacts or wire-wrapped contacts. The insertion devices are preferably overvoltage or overcurrent plugs or magazines.

In one preferred embodiment, the intermediate contact is in the form of an isolating contact, as a result of which the contact elements are connected to one another even without an insertion device.

In a further preferred embodiment, the contact elements have bent contact lugs in respect of which a separate contact part is arranged at the side, wherein the contact part together with the contact lugs of a contact element in the row on the front side and on the rear side in each case forms an intermediate contact. Two contact elements are therefore in each case connected via two intermediate contacts, which are preferably selectively accessible via openings from the front side or the rear side. In this case, the access openings for the intermediate contacts are preferably configured such that the insertion device can make contact at the same time with two adjacent intermediate contacts of a pair of contact elements in a row.

In a further preferred embodiment, a row of shielding plates is arranged between two adjacent contact pairs. The shielding plates are preferably designed such that they electromagnetically decouple contact pairs, which are in each case adjacent at the same time, in all four rows at the same time.

In an alternative embodiment, the contact elements have bent contact lugs, wherein the contact lugs of a contact element in a row on the front side and a contact element in a row on the rear side form an intermediate contact, and the contact lugs of two contact elements on the front side or the rear side which are opposite one another in different rows form a further contact. The further contact is preferably a switching contact. In this case, the opening of the further contact is preferably arranged on the opposite side to the opening for the intermediate contact. The contact lugs of two contact elements in the rows on the rear side preferably form the further contact which is accessible through an opening from the front side. Furthermore, shielding plates can also be provided in this embodiment.

The invention will be explained in more detail in the following text with reference to one preferred exemplary embodiment. In the figures:

FIG. 1 is a front view of a connecting module,

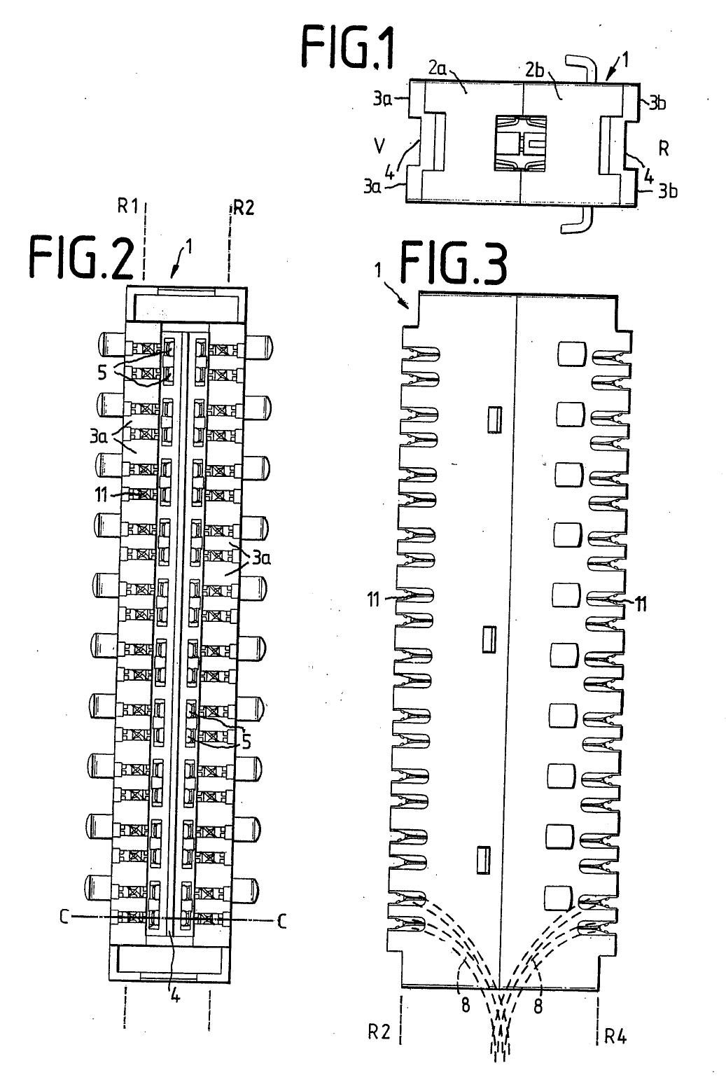

FIG. 2 is a top view of the connecting module,

FIG. 3 is a side view of the connecting module,

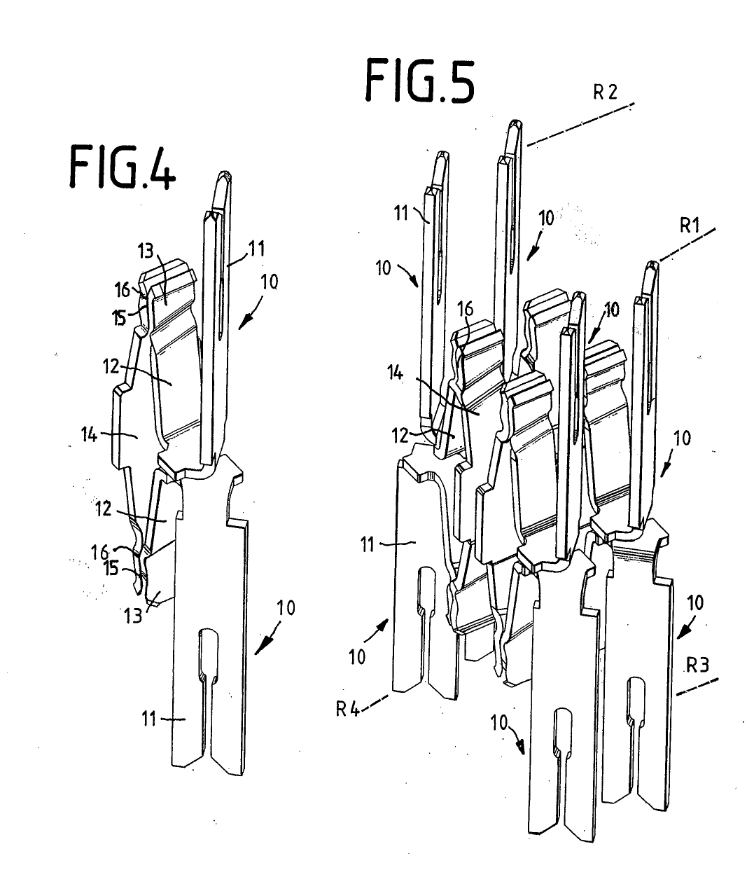

FIG. 4 is a perspective view of two contact elements having a separate contact part,

FIG. 5 is a perspective view of two contact elements per row,

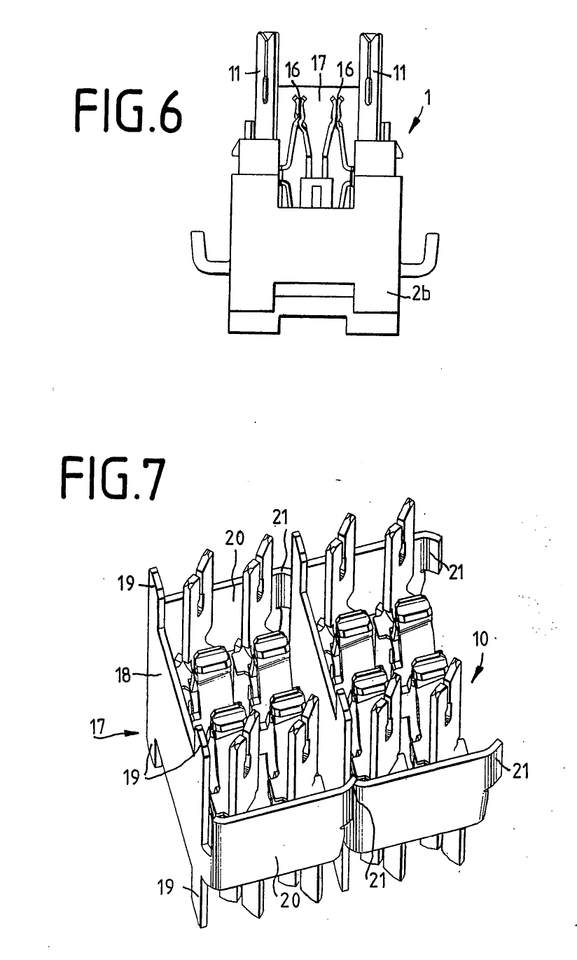

FIG. 6 is a front view of the connecting module with the housing upper part removed,

FIG. 7 is a perspective view of eight contact elements with shielding plates,

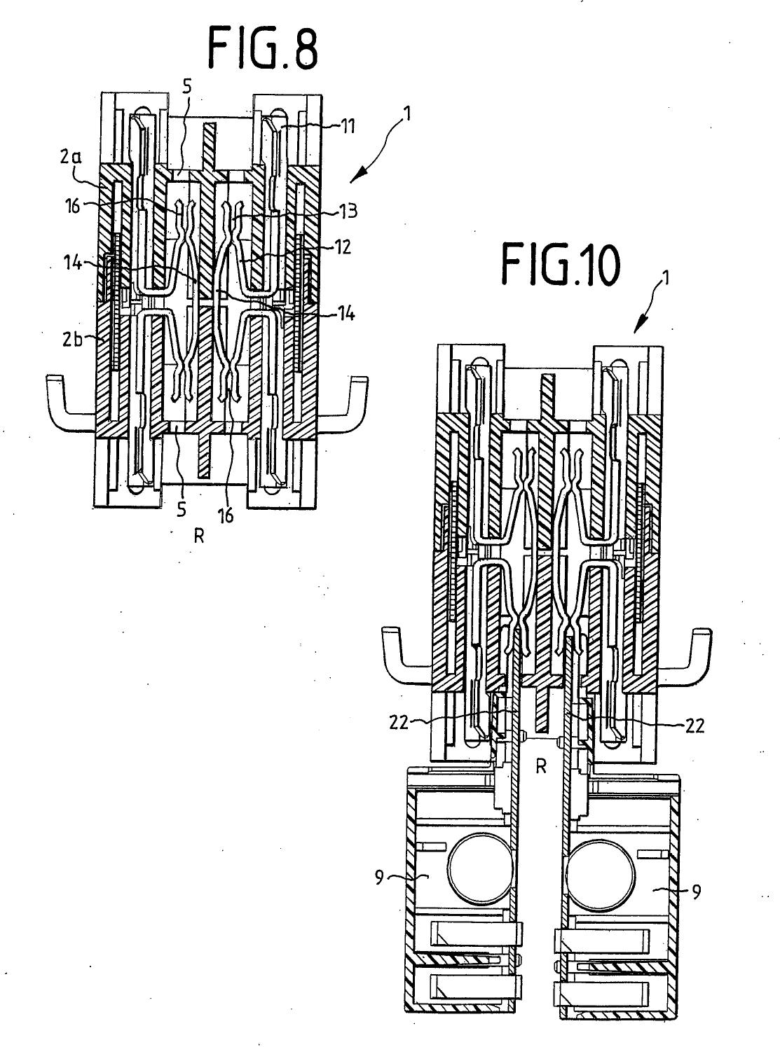

FIG. 8 is a cross-sectional view of the connecting module taken along the line C-C in FIG. 2 without insertion devices,

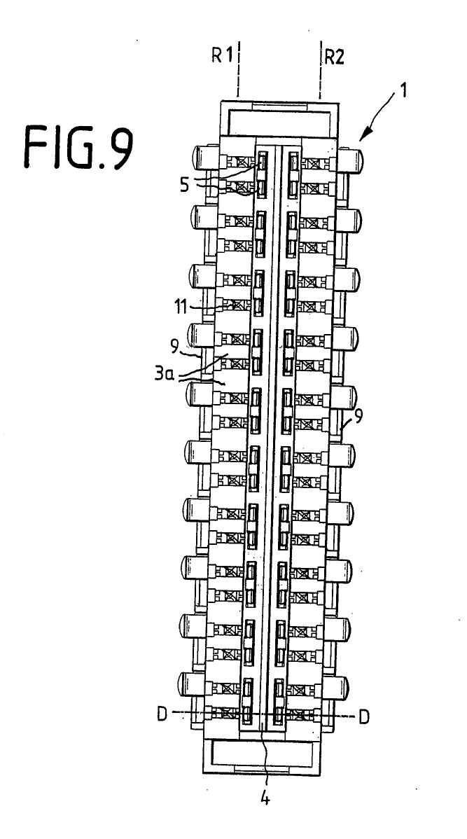

FIG. 9 is a top view of a connecting module with insertion devices inserted into the rear side,

FIG. 10 is a cross-sectional view of the connecting module taken along the line D-D shown in FIG. 9,

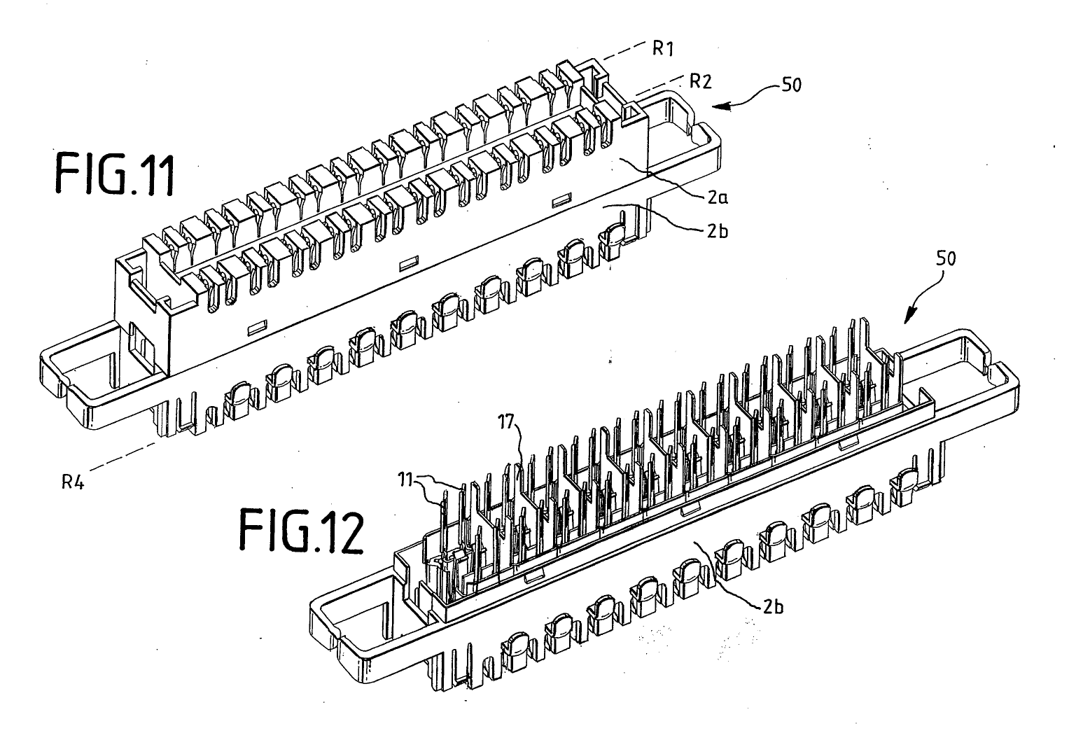

FIG. 11 is a perspective side view of the second embodiment of the connecting module,

FIG. 12 is a perspective side view of the connecting module shown in FIG. 11, with the housing upper part removed,

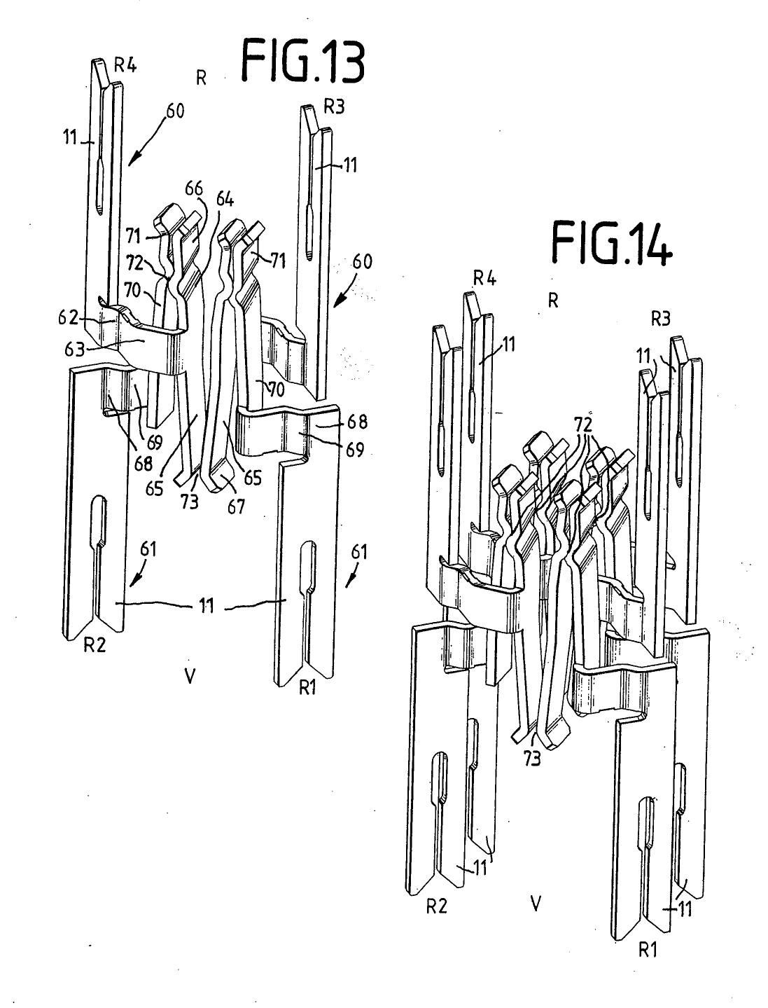

FIG. 13 is a perspective view of four contact elements,

FIG. 14 is a perspective view of eight contact elements,

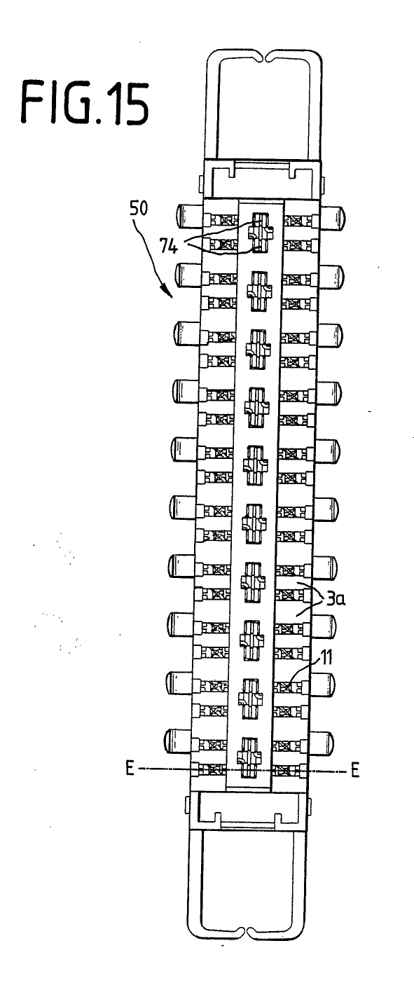

FIG. 15 is a top view of the connecting module,

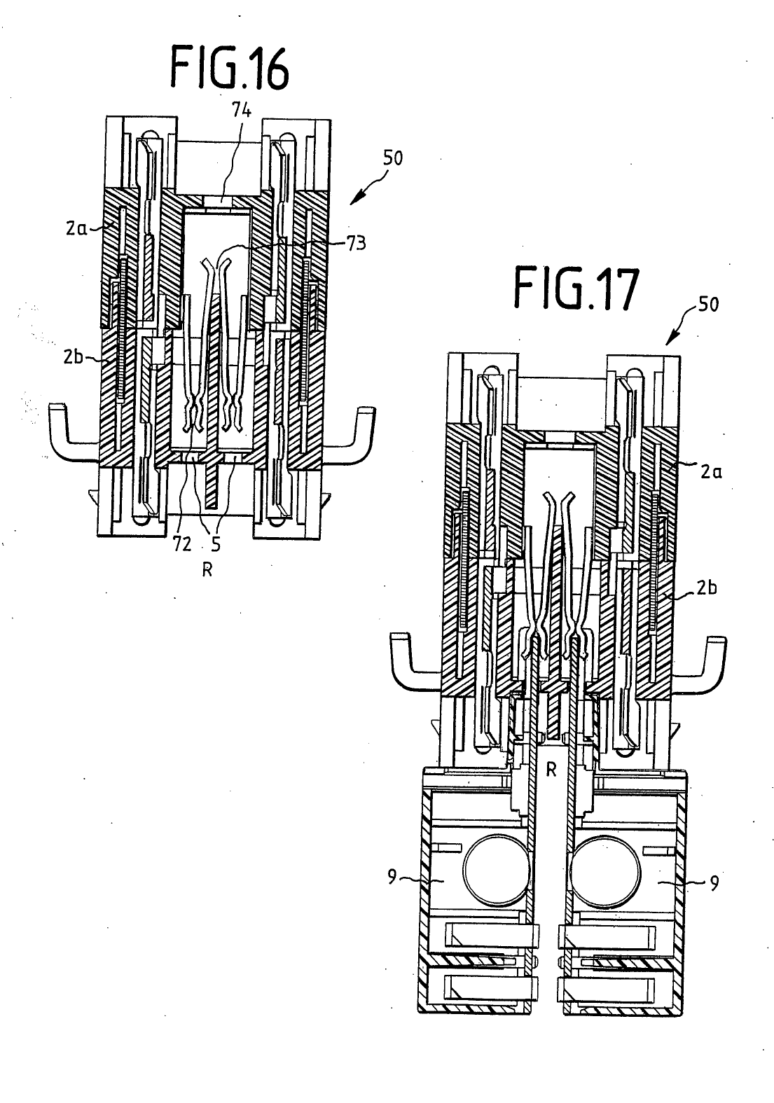

FIG. 16 is a cross-sectional view taken along the line E-E shown in FIG. 15, and

FIG. 17 is a cross-sectional view taken along the line E-E shown in FIG. 15 with insertion devices inserted.

The connecting module 1 shown in FIG. 1 comprises a housing upper part 2a and a housing lower part 2b, which are preferably latched to one another. The connecting module 1, to be precise the housing upper part 2a and the housing lower part 2b, comprises or comprise ribs 3a, 3b between which slots are formed in order to accommodate conductor connecting contacts 11, wherein the ribs 3a, 3b between conductor connecting contacts 11 which are associated in pairs are narrower than between conductor connecting contacts 11 of different contact pairs. As can be seen in particular in FIG. 2, the connecting module 1 has two rows R1, R2 of conductor connecting contacts 11, with twenty conductor connecting contacts 11 for ten pairs of conductors being arranged in each row R1, R2. The conductor connecting contacts 11 in the rows R1, R2 are in this case accessible from the front side V. In a corresponding manner, the connecting module 1 has two rows R3, R4 with conductor connecting contacts 11, which are accessible from the rear side R. The conductor connecting contacts 11 are in this case respectively a component of contact elements 10, which will be explained in more detail later. A channel 4 is located between the rows R1 and R2, as well as R3 and R4, and has openings 5 via which contact can be made with intermediate contacts 16, which will be explained later. The openings 5 are in this case arranged in pairs in the same way as the conductor connecting contacts 11. One pair of conductors 8 is in each case illustrated by dashed lines in FIG. 3 in this case, and these are connected to conductor connecting contacts 11 in the second row R2 and to conductor connecting contacts 11 in the fourth row R4.

The design of the contact elements 10 will now be explained in more detail with reference to FIGS. 4 and 5. In this case, it is assumed that the upper contact element 10 is associated with the row R1, and the lower contact element 10 is associated with the row R3. Each contact element 10 has a conductor connecting contact 11 in the form of an insulation displacement contact. Bent contact lugs 12 are arranged on the lower edge of the conductor connecting contacts 11 and are each bent back in the direction of the conductor connecting contact 11, with the contact lugs being rotated through 45° with respect to the conductor connecting contacts 11. At the upper end, the contact lugs 12 have bends 13. The two contact elements 10 are in this case arranged such that the two contact lugs 12 are aligned on the same side, such that the two conductor connecting contacts 11 are rotated through 90° about the longitudinal axis with respect to one another. The two contact lugs 12 are opposite a separate contact part 14, which has bends 15. The contact lugs 12 together with the contact part 14 in each case form an intermediate contact 16, which is in the form of an isolating contact, that is to say two contact elements 10 together with the contact part 14 form two intermediate contacts 16, with the upper intermediate contact 16 being accessible through an opening 5 from the front side V, and with the lower intermediate contact 16 being accessible through an opening 5 from the rear side R.

FIG. 6 shows the connecting module 1 with the housing upper part 2a removed, thus allowing a shielding plate 17 to be seen. Furthermore, two conductor connecting contacts 11 and two intermediate contacts 16 can be seen. The precise design of the shielding plate 17 can best be seen in FIG. 7. The shielding plate 17 essentially comprises a flat plate 18 on which extensions 19, in the form of tines, are in each case arranged in the area of the conductor connecting contacts 11. Furthermore, side angles 20 are arranged on the plate 18, which run virtually at right angles to the plate 18 and have angles 21 which are directed inward at the ends. A shield with a closed circumference is therefore formed together with a plate 18 of an adjacent shielding plate 17.

FIGS. 8 and 10 show a cross-sectional view of the connecting module 1, FIG. 10 (line D-D shown in FIG. 9) additionally illustrating insertion devices 9 in the form of overvoltage protection plugs. In this case, a printed circuit board 22 of the insertion device 9 in each case disconnects the lower isolating contact 16, which is accessible from the rear side R. The protection circuits of the insertion device 9 are then electrically connected via electrical conductor tracks on the printed circuit board 22 between the contact elements 10 in an upper row (for example, R1) and a lower row (for example, R3).

FIGS. 11 and 12 show a perspective view of a second embodiment of the connecting module 50, with the housing upper part 2a having been removed in FIG. 12, so that the shielding plates 17 can be seen. In this case, elements which are the same as those in the first embodiment are largely denoted with the same reference numerals.

FIGS. 13 and 14 show the contact elements 60, 61 of the connecting module 50. In this case, the contact elements 60 in the two rows R3, R4 once again have a conductor connecting contact 11 and a contact lug 62. The contact lug 62 has a bend 63 which extends virtually at right angles away from the lower end of the conductor connecting contact 11. Two contact strips 64, 65 originate from that end of the bend 63 which is remote from the connecting contact 11. In this case, the first contact strip 64 extends in the direction of the conductor connecting contact 11 of the contact element 60, and the second contact strip 65 extends in the direction of the conductor connecting contact 11 of the contact element 61. In this case, both contact strips 64, 65 have bends 66, 67 at their free ends. The contact element 61 likewise has a contact lug 68, which has a bend 69 at the lower edge of the conductor connecting contact 11, which extends virtually at right angles away from the conductor connecting contact 11. A contract strip 70 then originates from the bend 69 and extends in the direction of the contract strip 64 of the contact element 60. Furthermore, the contact strip 70 has a bend 71. The contract strip 64 of the contact element 60 and the contract strip 70 of the contract element 61 then once again form an intermediate contact 72, which is in the form of an isolating contact. At the same time, the two contact strips 65 of the contact elements 60 of the two rows R3, R4 form a further contact 73, which is in the form of a switching contact (that is to say it is open in the rest state). Opposite contact elements 60 in the rows R3 and R4 can be connected to one another via this further contact 73, wherein electrical functional units can additionally be connected between them, if required.

FIG. 15 shows a top view of the connecting module 50. In contrast to the connecting module 1, the connecting module 50 has openings 74 which are arranged centrally on the front side V, via which the further contacts 73 are accessible from the front side V. The rear side R is designed analogously to the first embodiment with openings 5 for the intermediate contacts 72, which are in each case offset laterally in the channel 4.

Finally, FIGS. 16 and 17 show a cross-sectional view of the connecting module 50 taken along the line E-E, wherein FIG. 17 also shows insertion devices 9 which are still inserted, in the form of overvoltage protection plugs.

### LIST OF PARTS

1 Connecting module
2a Housing upper part
2b Housing lower part
3a, 3b Ribs

### 4 Channel

### 5 Openings

8 Pair of conductors
9 Insertion device
10 Contact elements
11 Conductor connecting contacts
12 Contact lugs

### 13 Bends

14 Contact part
15

Bends

16 Intermediate contact
17 Shielding plate

### 18 Plate

### 19 Extensions

### 20, 21 Angles

22 Printed circuit board
50 Connecting module
60, 61 Contact elements

### 62 Contact lug

### 63 Bend

64, 65 Contact strips

### 66, 67 Bends

### 68 Contact lug

### 69 Bend

70 Contact strips

### 71 Bend

72 Intermediate contact
73 Further contact

### 74 Openings

### R1-R4 Rows

R Rear side
V Front side

1. A connecting module comprising:
two parallel rows of contact elements having conductor connecting contacts which are accessible from a front side of the connecting module, and two parallel rows of contact elements having conductor connecting contacts which are accessible from a rear side of the connecting module, wherein the conductor connecting contacts in one row on the front side are in each case connected to a conductor connecting contact in one row on the rear side via at least an intermediate contact, into which an insertion device can be inserted.

2. The connecting module claimed in claim 1, wherein the intermediate contact is in the form of an isolating contact.

3. The connecting module as claimed in claim 1, wherein the contact elements have bent contact lugs in respect of which a separate contact part is arranged at the side, wherein the contact part together with the contact lugs of a contact element in the row on the front side and on the rear side in each case forms an intermediate contact.

4. The connecting module claimed in claim 3, wherein openings are provided in each case in the front side and the rear side, such that one intermediate contact is in each case accessible from the front side and one intermediate contact is accessible from the rear side.

5. The connecting module claimed in claim 1, wherein a row of shielding plates is arranged between adjacent contact pairs of contact elements.

6. The connecting module claimed in claim 1, wherein the contact elements have bent contact lugs, wherein the contact lugs of a contact element in a row on the front side and a contact element in a row on the rear side form an intermediate contact, and the contact lugs of two contact elements on the front side or rear side which are opposite one another in different rows form a further contact.

7. The connecting module claimed in claim 6, wherein the further contact is a switching contact.

8. The connecting module claimed in claim 6, wherein the contact lugs of two contact elements on the rear side form the further contact which is accessible through an opening from the front side.
